(19) United States
(12) Patent Application Publication
(10) Pub. No.: US 2016/0275430 A1
(43) Pub. Date: Sep. 22, 2016

(54) METHODS FOR SELECTING AND SEQUENCING OPTIMAL PROJECT REQUIREMENTS IN A PROJECT WITH MULTI-PASS EXECUTION AND DEVICES THEREOF

(71) Applicant: Wipro Limited, Bangalore, KA (US)

(72) Inventor: Sourav Sam Bhattacharya, Foundation Hills, AZ (US)

(21) Appl. No.: 14/660,371

(22) Filed: Mar. 17, 2015

(51) Int. Cl. G06Q 10/06

(52) U.S. Cl. CPC G06Q 10/06316; G06Q 10/06312; G06Q 10/06315

(57) ABSTRACT

This technology obtains requirements data on types of requirements for a project. Next, each conflict between one of the requirements in one of the types of requirements and one of the requirements in another one of the types of requirements is identified. In each of the identified conflicts one of the one of the requirements in one of the types of requirements or the one of the requirements in another one of the types of requirements is selected based on stored attribute value data for the obtained requirements retrieved from one or more value databases. A schedule with a sequence of execution phases of the project is generated based on any non-conflicting ones of the requirements and the selected one of the one of the requirements in one of the types requirements and one of the requirements in another one of the types of requirements for each of the identified conflicts.

### FIELD

This technology relates to methods for selecting and sequencing optimal project requirements in a project with multi-pass execution leading to earned value management maximization and devices thereof.

### BACKGROUND

Timely and right decision making in a project is pivotal to the successful completion of the project. Typically, the success of a project may be defined in terms of various parameters, such as cost, schedule, scope, and risk management, while ensuring proper people management and customer satisfaction.

Unfortunately, it is not uncommon for attributes of a project to be aligned towards different objectives. Additionally, it is common to find projects with requirements that contradict with each other, either partially or totally, leaving the dilemma of which one to execute and which one to sacrifice (i.e., not execute). Any requirements left un-executed may lead to negative project attributes and outcomes, such as a compliance violation, a customer service level agreement (SLA) miss, an increased cost, or a deviated scope by way of example only. As a result, there has been a major optimization challenge in selecting the requirements to execute, out of the ensemble of conflicting requirements which has not been successfully addressed with existing project management software technology.

To add further complexity to the timing of the selection and execution of requirements of a project, the project may execute in multiple phases. By way of example only, multi-pass execution is often a typical scenario when software is released in versions or a software project is executed iteratively. This multi-phase execution provides the possibility to catch up meeting a requirement left unaddressed in a previous phase and this aspect has not been successfully addressed with existing project management software technology.

To add even further complexity, the success of a project also is affected by any change in the values associated with completion of the different requirements. With respect to these types of values, Earned Value Management

(EVM) is a well-known quantitative optimization technique applied to project management. The EVM concept generates a “value” as a success measure of a project. The “value” is usually a single number, but it can be extended to a vector as well. The vector would have k different elements, each referring to the project's accomplishment in a certain direction or towards a certain objective. By way of example only, a project may have an EVM vector with first vector element EV_1 as the business value, a second vector element EV_2 as the security value, and a third vector element EV_3 as the reliability value.

One of the problems is when EV_1 is inversely proportional to EV_2 and vice versa. For example, when a large number of security defects are identified in a software development project and cannot fix the security defects within the release schedule, leading to an execution decision on whether to waive the security requirements while meeting the release schedule.

In this example, EV_1 (business value) is maximized, while EV_2 (security value) is foregone. When the project is executed in the 2^{nd} iterative cycle, the project may pick up the previously left unaddressed security requirements (in group EV_2) and attempt to fix the security defects. If all the security requirements are indeed addressed in 2^{nd} cycle, then both EV_1 and EV_2 satisfied. Unfortunately, existing software project management tools are unable to analyze and provide an optimized set of requirements, in particular with a project with a multi-phase execution. As a result, with existing software project management tools the section of requirements is often incorrect, untimely and at times hazardous for the EVM of the project.

### SUMMARY

A method for optimizing sequencing and selecting requirements in a project includes obtaining by a project management computing device requirements data on two or more types of requirements for a project. In the obtained requirements data each conflict between one of the requirements in one of the types of requirements and one of the requirements in another one of the types of requirements is identified by the project management computing device. In each of the identified conflicts one of the one of the requirements in one of the types of requirements or the one of the requirements in another one of the types of requirements is selected by the project management computing device based on stored attribute value data for the obtained requirements retrieved from one or more value databases. A schedule with a sequence of execution in one or more phases of the project is generated by the project management computing device based on any non-conflicting ones of the requirements and the selected one of the one of the requirements in one of the types requirements and one of the requirements in another one of the types of requirements for each of the identified conflicts.

A non-transitory computer readable medium having stored thereon instructions for optimizing sequencing and selecting requirements in a project which when executed by a processor, causes the processor to perform steps including obtaining requirements data on two or more types of requirements for a project. In the obtained requirements data each conflict between one of the requirements in one of the types of requirements and one of the requirements in another one of the types of requirements is identified. In each of the identified conflicts one of the one of the requirements in one of the types of requirements or the one of the requirements in another one of the types of requirements is selected based on stored attribute value data for the obtained requirements retrieved from one or more value databases. A schedule with a sequence of execution in one or more phases of the project is generated based on any non-conflicting ones of the requirements and the selected one of the one of the requirements in one of the types requirements and one of the requirements in another one of the types of requirements for each of the identified conflicts.

A project management computing device has a memory coupled to a processor which is configured to be capable of executing programmed instructions comprising and stored in the memory to obtain requirements data on two or more types of requirements for a project. In the obtained requirements data each conflict between one of the requirements in one of the types of requirements and one of the requirements in another one of the types of requirements is identified. In each of the identified conflicts one of the one of the requirements in one of the types of requirements or the one of the requirements in another one of the types of requirements is selected based on stored attribute value data for the obtained requirements retrieved from one or more value databases. A schedule with a sequence of execution in one or more phases of the project is generated based on any non-conflicting ones of the requirements and the selected one of the one of the requirements in one of the types requirements and one of the requirements in another one of the types of requirements for each of the identified conflicts.

This technology provides a number of advantages including providing methods, non-transitory computer readable medium and devices that select and sequence optimal project requirements in a project with multi-pass execution leading to earned value management maximization. In particular, this technology can automatically sequencing and scheduling of the execution of requirements across multiple phases of the project with effective management of partial and full conflicts. As a result, this technology generates scheduling data which has a global execution view as opposed to a local execution view. Further this technology is able avoid forbidden spaces with respect to particular designated requirements reflecting an organization's legal, business and/or logistic boundaries.

### BRIEF DESCRIPTION OF THE DRAWINGS

FIG. 1 is a diagram of an example of an environment with an example of the project management computing device that may manage selecting and sequencing optimal project requirements in a project with multi-pass execution leading to earned value management maximization;

FIG. 2 is a block diagram of the example of the project management computing device shown in FIG. 1;

FIG. 3 is a flowchart of an example of a method for managing selecting and sequencing optimal project requirements in a project with multi-pass execution leading to earned value management maximization; and

FIG. 4 is a flowchart of an example of another method for managing selecting and sequencing optimal project requirements in a project with multi-pass execution leading to earned value management maximization.

### DETAILED DESCRIPTION

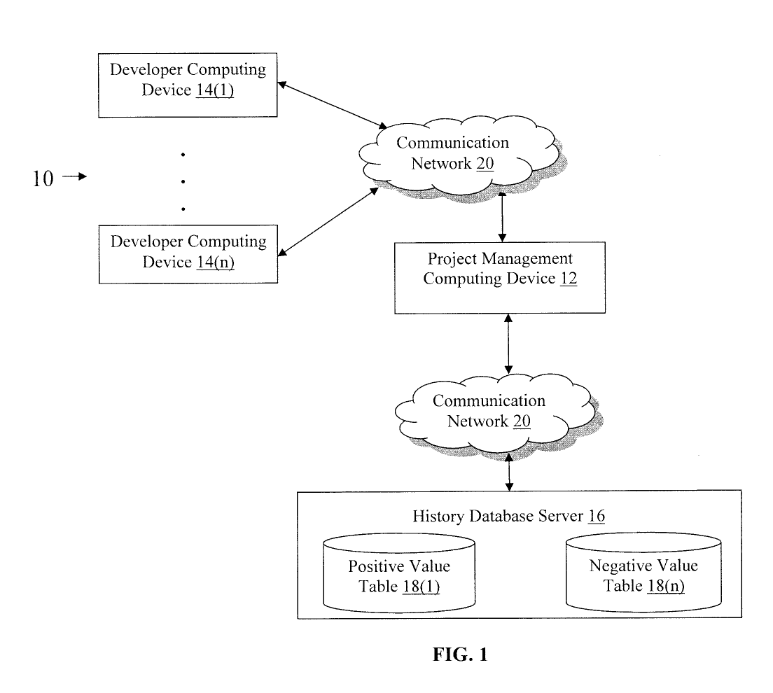

An environment 10 with exemplary project management computing device 12 is illustrated in FIGS. 1-4. In this particular example, the environment 10 includes the project management computing device 12, developer computing devices 14(1)-14(n), and a history database server 16 with a positive value table 18(1) and a negative value table 18(2) coupled via one or more communication networks 20, although the environment could include other types and numbers of systems, devices, components, and/or other elements in other configurations. This technology provides a number of advantages including providing methods, non-transitory computer readable medium and devices that select and sequence optimal project requirements in a project with multi-pass execution leading to earned value management maximization.

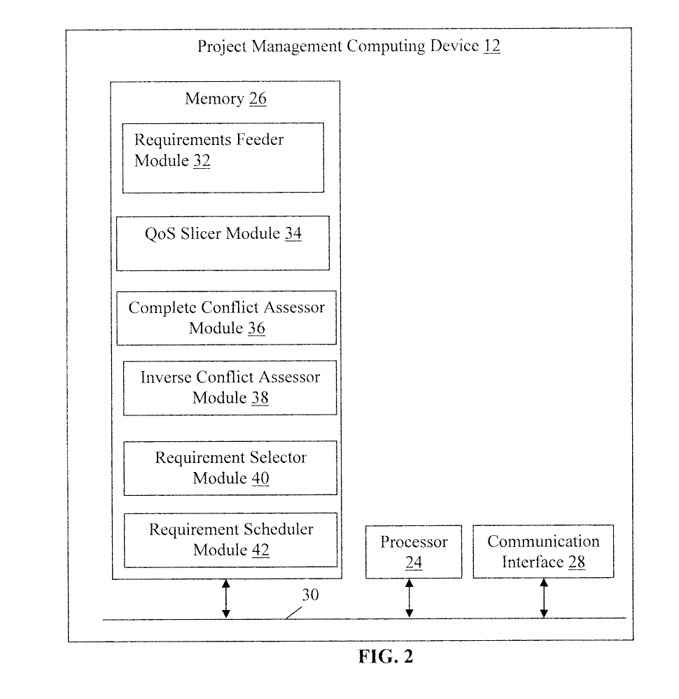

Referring more specifically to FIGS. 1-2, the project management computing device 12 that may select and sequence optimal project requirements in a project with multi-pass execution leading to earned value management maximization, although the computing device can perform other types and/or numbers of functions and/or other operations. In this particular example, the project management computing device 12 includes a processor 24, a memory 26, and a communication interface 28 which are coupled together by a bus 30, although the project management computing device 12 may include other types and/or numbers of physical and/or virtual systems, devices, components, and/or other elements in other configurations.

The processor 24 of the project management computing device 12 may execute one or more programmed instructions stored in the memory 26 for selecting and sequencing optimal project requirements in a project with multi-pass execution leading to earned value management maximization as illustrated and described in the examples herein, although other types and/or numbers of instructions can be performed. The processor 24 of the project management computing device 12 may include one or more central processing units and/or general purpose processors with one or more processing cores, for example.

The memory 26 of the project management computing device 12 stores the programmed instructions and other data for one or more aspects of the present technology as described and illustrated herein, although some or all of the programmed instructions could be stored and executed elsewhere. A variety of different types of memory storage devices, such as a random access memory (RAM) or a read only memory (ROM) in the system or a, hard disk, CD ROM, DVD ROM, or other computer readable medium which is read from and written to by a magnetic, optical, or other reading and writing system that is coupled to the processor 24, can be used for the memory 26. In this particular example, the memory 26 includes a requirements feeder module 32, a QoS slicer module 34, a complete conflict assessor module 36, an inverse assessor module 38, a requirement selector module 40, and a requirement scheduler module 42, although the memory 26 can comprise other types and/or numbers of other modules, programmed instructions and/or other data. The instructions, steps, and/or data of the requirements feeder module 32, the QoS slicer module 34, the complete conflict assessor module 36, the inverse assessor module 38, the requirement selector module 40, and the requirement scheduler module 42 are illustrated and described by way of the examples herein.

The requirements feeder module 32 may comprise executable programmed instructions which are configured to be capable of obtaining and combining requirements for a project which may have one phase of execution or multiple phases of execution into a single, indexed and traceable set of requirements each with an identification, although other manners for obtaining and/or processing the requirements could be used. The requirements feeder module 32 may comprise executable programmed instructions which are configured to be capable of using a lightweight database or a spreadsheet for numbering and traceability of the requirements for a project which may be stored in memory 26, although the requirements can be processed and/or stored in other manners and/or locations.

The QoS slicer module 34 may comprise executable programmed instructions which are configured to be capable of parsing the obtained requirements into different types of requirements, such as business requirements, security requirements, and reliability requirements by way of example only. Additionally, the QoS slicer module 34 may comprise executable programmed instructions which are configured to be capable of identifying and parsing requirements that overlap into two or more of the types of requirements based on stored parsing data or administrator input.

The complete conflict assessor module 36 may comprise executable programmed instructions which are configured to be capable of identifying requirements that completely contradict each other. A complete conflict occurs when one requirement is in absolute contradiction to the other requirement. In this particular example, when a complete conflict is identified the output from the complete conflict assessor module 36 is a list of conflicting requirements sent, in this example as a tuple, to the requirements selector module 40. For other requirements, the complete conflict assessor module 36 passes them to the inverse conflict assessor module 38 as illustrated and described below.

The inverse conflict assessor module 38 may comprise executable programmed instructions which are configured to be capable of receiving requirements that are either independent of each other or may have an inverse relationship, although requirements with other types of relationships could be processed here. Additionally, inverse conflict assessor module 38 may also determine when two requirements are independent of each other if the two requirements do not share any physical or logical resource. Further, the inverse conflict assessor module 38 may identify when requirements that do not contradict each other still have an inverse satisfaction relationship. The inverse conflict assessor module 38 may also operate using a shared resource (physical or logical) analysis to identify an inverse relationship as illustrated described with examples herein, although other manners for identifying and managing partial conflicts can be used. When an inverse relationship is identified by the inverse conflict assessor module 38, the conflict determination is not purely binary, but instead the conflict determination is on a %-satisfaction ratio, although other manners for analyzing the inverse relationship could be used. Based on this inverse relationship determination, the inverse conflict assessor module 38 may also either pass the requirements with the inverse relationship to the requirement selector module 40 to select between the two requirements or if the inverse relationship is acceptable for the phase of the project to the requirement scheduler module 42 based on stored metrics data or input data from an administrator, although other manners for making this determination can be used.

The requirement selector module 40 may comprise executable programmed instructions which are configured to be capable of analyzing and selecting one requirement from each set of conflicting requirements. Each identified conflict may have two or more requirements and the output from the requirement selector module 40 is the one selected requirement while the other requirements are designated as “Not Satisfied” and may be designated for scheduling in a subsequent phase of the project.

The criteria used by the requirement selector module 40 to select one requirement out of each of the sets of conflicting requirements is based upon values corresponding to each of the conflicting requirements stored in the positive and negative value tables, although other manners for selecting could be used. The values corresponding to each of the conflicting requirements indicate how much the positive value would be if a requirement is executed in the current phase, as opposed to how much the loss would be if the requirement is not executed in the current phase. The positive and negative values are retrieved by the requirement selector module 40 using the same identification data used by the requirement feeder module 32, although other manners for retrieving the value data associated with the conflicting requirements of the project could be used.

The requirement scheduler module 42 may comprise executable programmed instructions which are configured to be capable of scheduling the non-conflicting requirements and the selected ones of the sets of conflicting requirements. The requirement scheduler module 42 may also schedule the requirements at different phases of execution of a project, such as with requirements with an acceptable inverse relationship, but which may not be fully executed in one phase of execution and may require execution in a subsequent phase to complete by way of example only. The process of generating the schedule is repetitive and continues until all the requirements are commissioned and executed for the project.

The communication interface 28 of the project management computing device 12 operatively couples and communicates between one or more of developer computing devices 14(1)-14(n) and the history database server 16 with a positive value table 18(1) and a negative value table 18(2), although other types and/or numbers of communication networks or systems with other types and/or numbers of connections and configurations to other devices and elements. By way of example only, the communication networks 20 can use TCP/IP over Ethernet and industry-standard protocols, including NFS, CIFS, SOAP, XML, LDAP, SCSI, and SNMP, although other types and numbers of communication networks, can be used. The communication networks 20 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like.

Each of the developer computing devices 14(1)-14(n) may run applications for developing one or more projects in one or more phases, although each of the developer computing devices 14(1)-14(n) may perform other types and/or numbers of other functions and/or other operations. Each of the developer computing devices 14(1)-14(n) may include a processor, a memory, and a communication interface, which are coupled together by a bus or other link, although other numbers and types of devices and/or nodes as well as other network elements could be used.

The history database server 16 may include a processor, a memory, and a communication interface, which are coupled together by a bus or other link, although other numbers and types of devices and/or nodes as well as other network elements could be used. Additionally, in this particular example the history database server 16 includes a positive value table 18(1) and a negative value table 18(2) that each may store and provide value data for positive values and negative values for project requirements, although other types and/or amounts of data may be stored and/or the data may be stored in other locations, such as in memory 26 in the project management computing device 12. The positive value table 18(1) and negative value table 18(2) are indexed to the requirements in the same manner as done by the requirements feeder module 32 and stores the positive values in the positive value table 18(1) and the negative values in the negative value table 18(2) for each requirement, although other manners for indexing and/or storing may be used.

Initially, the positive and/or negative values may be input data from an administrator, however subsequently the positive and/or negative values are recycled back from a previous iteration of this or another project based on the actual value earned in a previous phase of the project when a particular requirement was indeed satisfied, as opposed to how much value was lost (aka. penalty imposed) when another requirement was missed.

The positive values in the positive value table 18(1) are indexed to the requirement in the same manner used by the requirement feeder module 32, although other manners of indexing and/or storing the positive values could be used. By way of example only of a positive value, a business requirement to provide a help dialogue box to the end user may have a perceived user satisfaction/product feature value of $1000.00. A business requirement to provide another user feature to do a self-service user registration may have a product feature value of $5000.00.

The negative values in the negative value table 18(1) are indexed to the requirement in the same manner used by the requirement feeder module 32, although other manners of indexing and/or storing the negative values could be used. By way of example only, with business functional requirements, usually the positive value and negative values are identical, indicating the value gained (if the feature is provided) is the same as value lost (if the feature is absent). However, by way of example only for QoS requirement, like security or reliability, usually the negative value for a missed requirement is much higher than the positive value. For example, if a project meets a 5-nine's reliability value, it may meet the designated product feature and add a positive value of $10,000.00, whereas if the same requirement is not satisfied, i.e., 5-nine's reliability is not met, then the product may be considered unacceptable and the negative value would be a very high (several $-M range) penalty, including bad reputation and loss of revenue.

Although the exemplary network environment 10 with the project management computing device 12, the developer computing devices 14(1)-14(n), the history database server 16 with the positive value table 18(1) and the negative value table 18(2) and the communication networks 20 are described and illustrated herein, other types and numbers of systems, devices, components, and elements in other topologies can be used. It is to be understood that the systems of the examples described herein are for exemplary purposes, as many variations of the specific hardware and software used to implement the examples are possible, as will be appreciated by those skilled in the relevant art(s).

In addition, two or more computing systems or devices can be substituted for any one of the systems or devices in any example. Accordingly, principles and advantages of distributed processing, such as redundancy and replication also can be implemented, as desired, to increase the robustness and performance of the devices, apparatuses, and systems of the examples. The examples may also be implemented on computer system(s) that extend across any suitable network using any suitable interface mechanisms and traffic technologies, including by way of example only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

The examples also may be embodied as a non-transitory computer readable medium having instructions stored thereon for one or more aspects of the present technology as described and illustrated by way of the examples herein, as described herein, which when executed by the processor, cause the processor to carry out the steps necessary to implement the methods of this technology as described and illustrated with the examples herein.

An example of a method for optimizing sequencing and selecting requirements in a project will now be described with reference to FIGS. 1-3. More specifically, this particular example relates to a project with three sets of requirements: Group A—list of business requirements, including Functional Requirements and Cost and Schedule Requirements; Group B—List of Software Security and Compliance Requirements, whose complete satisfaction may be infeasible or contradictory to one or more Group A requirements, and certain violations of whose may lead to a legal breach, essentially creating a dead-space in the EVM Vector; and Group C—List of project execution versions of the project, including start and stop schedule for each phase.

With this particular example, the method as described in greater detail below will determine: (a) Which ensemble of requirements from Groups A and B should be chosen to execute the project in each phase of Group C; (b) In what sequence or order of execution, the requirements should be executed such that the total value (Business and Security—combined) of the EVM vector is optimized, and the project does not reach into a “Forbidden Space” of the EVM Vector.

The method is designed as an iterative selector, operating in a dynamic programming capacity, so that if there are N number of requirements, the method would execute N times. By way of example only, with a project having 200 business requirements, 60 security requirements, and 30 other QoS requirements, the said system would execute 290 times. In other words, in this example the method will select one requirement at a time, and repeat until all executable requirements are exhausted.

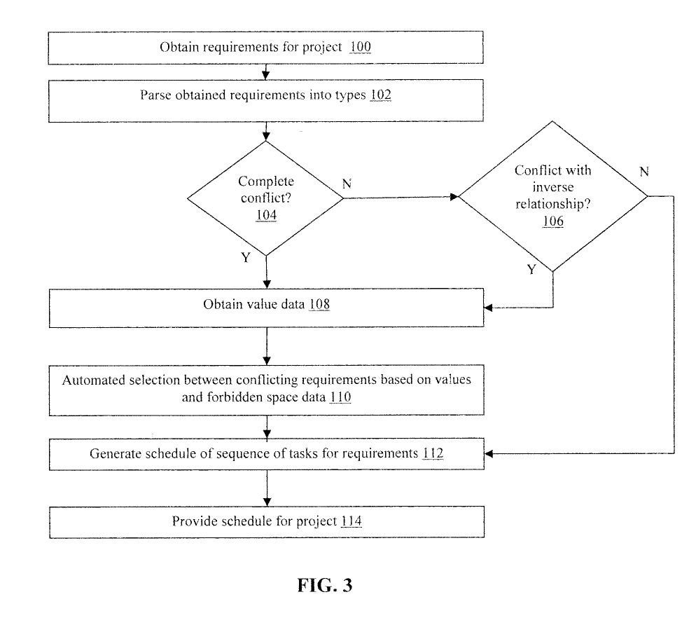

Referring more specifically to FIG. 3, in this example in step 100 the requirements feeder module 32 in the project management computing device 12 may obtain and combine requirements for a project which may have one phase of execution or multiple phases of execution, e.g. Group C described above for this example, into a single, indexed and traceable set of requirements each with an identification, although other manners for obtaining and/or processing the requirements could be used. The requirements feeder module 32 the obtained requirements are indexed with identification data in a lightweight database or a spreadsheet for numbering and traceability of the requirements for a project which may be stored in memory 26, although the requirements can be processed and/or stored in other manners and/or locations.

In step 102, the QoS slicer module 34 in the project management computing device 12 parses the obtained requirements into different types of requirements, such as business requirements, security requirements, and reliability requirements by way of example only. Additionally, the QoS slicer module 34 in the project management computing device 12 is capable of identifying and parsing requirements that overlap into two or more of the types of requirements based on stored parsing data or administrator input. By way of example only, a security requirement may also be listed as a business requirement so the QoS slicer module 34 will identify one type for this requirement.

In step 104, the complete conflict assessor module 36 in the project management computing device 12 determines when two or more requirements completely contradict each other. By way of example only, a security requirement may prevent multiple login (from the same user ID) while a business requirements may allow it as a user friendly product feature. With such conflict where meeting one requirement fundamentally disqualifies the other (contradictory) requirement, the complete conflict assessor module 36 may identify the complete conflict using a shared resource based analysis, although other manners for identifying the complete conflict could be used. As discussed earlier, the QoS slicer module 34 in the project management computing device 12 maps all requirements to a resource impact matrix, where a resource can be a physical resource or a logical resource, although other manners of mapping could be used. In the example of the complete conflict discussed above, a login session is the shared logical resource which is contested between the security requirement and the business requirement. A complete conflict occurs when one requirement is in absolute contradiction to the other requirement.

By way of another example, the conflict evaluation logic that may be used by the complete conflict assessor module 36 in the project management computing device 12 may be based upon a shared resource R/W conflict idea. A shared resource may be physical, or logical. Physical shared resources may be a user interface (UI) screen, messages to/from users, network traffic, disk usage, or a database schema by way of example only. A logical shared resource may be cost, schedule, scope, or human factors by way of example only.

Two requirements may be determined to be independent of each other by the complete conflict assessor module 36 if they do not share a common resource. Even if they share a common resource, but not in a Write-capacity (“Write” in this example means attempting to change the value of the shared resource), then the complete conflict assessor module 36 may determine they are independent. In this particular example, when two or more requirements each attempt to “Write” (i.e., alter) the value of the shared resource, then a conflict is noted by the complete conflict assessor module 36.

When there is a conflict identified, there may be two subcategories. The complete conflict category means one requirement must execute while the other requirement must not. This is a situation where both requirements are attempting to alter the value of the shared resource, and only one shall be allowed, while the other cannot be. In some examples, particularly with logical shared resources, it may be possible to partially alter the value of the shared resource by more than one requirement. One such example is: a schedule (which is a shared, logical, resource) being altered by 20% extension at the reduction of 30% cost (which is another, logical, shared resource) reduction.

Accordingly, if in step 104 the complete conflict assessor module 36 in the project management computing device 12 determine two or more requirements completely contradict each other, then data on sets of conflicting requirements is output from the complete conflict assessor module 36 as a tuple to the requirements selector module 40 in this example and the Yes Branch is taken to step 108. If in step 104 the complete conflict assessor module 36 in the project management computing device 12 determine two or more requirements do not completely contradict each other, then the complete conflict assessor module 36 passes the requirements to the inverse conflict assessor module 38 and the Yes branch is taken to step 106.

In step 106, the inverse conflict assessor module 38 in the project management computing device 12 determines when any sets of received requirements have an inverse relationship requiring a determination of which one of the requirements to select. In this particular example, inverse conflict assessor module 38 may determine when two or more requirements are independent of each other when the requirements do not share any physical or logical resource. By way of example only, independent requirements may be a code security requirement and a business requirement to provide a user function which would not contradict. Additionally, the inverse conflict assessor module determines when requirements that are independent, still have an inverse satisfaction relationship. By way of example only, with a code security requirement and a schedule requirement, the schedule requirement to complete the code, test and deploy the software within a certain deadline may not allow or provide sufficient time for the security requirement to fix all code security related defects. Therefore, the more code security defects are detected, then the less likely completion of the schedule requirement would also satisfy completion of the security requirement. The inverse conflict assessor module 38 may identify these inverse relationships using an identification of a shared resource (physical or logical), although other manners for identifying and managing partial conflicts can be used.

When an inverse relationship is identified by the inverse conflict assessor module 38, the conflict determination is not purely binary, but instead in this particular example the conflict determination is on a percentage (%)-satisfaction ratio. By way of example only, when a schedule requirements has an identified inverse relationship with a security requirement to complete code security defect fixes, the inverse conflict assessor module 38 may determine that to fix (30%, 50%, 80%, and 100%) of the security defects, one needs to extend the schedule by (20%, 40%, 90%, and 150%) beyond deadline. Based on this inverse relationship determination, the inverse conflict assessor module 38 may either pass the requirements with the inverse relationship to the requirement selector module 40 to select between the two requirements or if the inverse relationship is acceptable for the phase of the project to the requirement scheduler module 42 based on stored tables of data of minimum acceptable percentage completion requirements for each of the requirements at different phases of execution or input data from an administrator, although other manners for making this determination can be used.

Accordingly, if in step 106 when the inverse conflict assessor module 38 determines one of the sets of received requirements does not have an inverse relationship requiring a determination of which one of the requirements to select because then the No branch is taken to step 112. If in step 106 when the inverse conflict assessor module 38 determines one of the sets of received requirements has an inverse relationship requiring a determination of which one of the requirements to select because then the Yes branch is taken to step 108.

In step 108, the project management computing device 12 uses the identification data associated with the requirements in a conflicting set of requirements to retrieve positive value data from the positive value table 18(1) and/or negative value data from the negative value table 18(2) in the history database server 18, although the positive value data and/or negative value can be obtained in other manners and/or from other sources. Additionally, the project management computing device 12 may also search for any forbidden space data. i.e. data indicating a particular requirement must be selected, in the history database server 18, although the forbidden space data can be obtained in other manners and/or from other sources.

In step 110, the requirement selector module 40 in the project management computing device 12 may analyze and select one requirement from each set of conflicting requirements based on the obtained positive value data, negative value data, and/or forbidden space data, although the selection may be made based on other types and/or numbers of other parameters. The positive values corresponding to each of the conflicting requirements indicate how much the positive value would be if the requirement is executed in the next phase of the project, as opposed to how much the loss would be if the requirement is not executed in the next phase of the project. In this particular example, the positive and negative value tables are retrieved by the requirement selector module 40 using the same identification data used by the requirement feeder module 32, although other manners for retrieving the positive and negative value data could be used. It also is to be noted that a particular requirement's positive value and negative value may not be equal. Security requirements are good examples of such unequal positive and negative values. Satisfaction of a requirement leads to a small increase (hence, a small positive value) in the security compliance posture, whereas violation of the same requirement leads to a total compliance failure (usually a much higher negative value).

By way of another example, the selection by the requirement selector module 40 may compare the potential EV to earn for each conflicting requirement (R-k), by comparing the positive values of the selected requirements, while subtracting the maximum of the negative values for each one of the other requirements which would not be selected when R_k is selected. In this example, let Pos(R_k) be the positive table value for requirement R_k, and Neg(R_k) be its negative table value. If R_k is selected, the Post(R_k) is the gained EV, while summation of all other Neg(R_j) (j not equal to k) would be the forfeited value. Therefore, the net gain by selecting R_k would be

Pos(R_k) minus Sum [ for all j, j not equal to k, Neg(R_j) ]

The above formula is repeated for all k by the project management computing device 12, and whichever requirement leads to the maximum value for the above expression would be the one chosen by the requirement selector module 40 as the winning contestant requirement.

Accordingly, when the selection is made in step 210 by the requirement selector module 40, the selection in this example is output to the requirement scheduler module 42 and the other non-selected requirements are designated as “Not Satisfied” and may be designated for scheduling in a subsequent phase of the project, although the selected requirements may be output in other manners and/or the non-selected requirements may receive other types of designations or processing.

In step 112, the requirement scheduler module 42 in the project management computing device 12 may scheduling the received non-conflicting requirements and the selected ones of the sets of conflicting requirements in the next phase of the project and the uncompleted non-conflicting requirements and/or the unselected ones of the sets of conflicting requirements in future phases of the project, although other manners for scheduling the requirements of a project for execution can be used. By way of example only, requirements with an acceptable inverse relationship, but which may not be fully executed in one phase of execution may be scheduled in a subsequent phase of execution of the project. This method of generating the schedule is repetitive and continues until all the requirements for the project are processed.

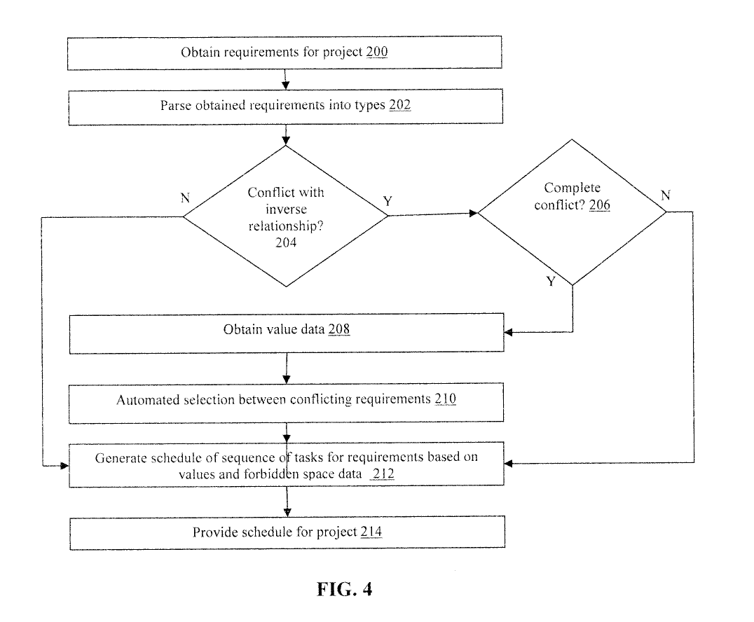

An example of another method for optimizing sequencing and selecting requirements in a project will now be described with reference to FIGS. 1-4. The steps in this method are the same in operation and structure as the ones described with reference to FIGS. 1-3, except as illustrated and described herein. Steps in the method illustrated and described with reference to FIG. 4 which are like those in the method illustrated and described with reference to FIG. 3 will have like reference numerals and will not be described in detail again herein. In this example, step 200 is the same as step 100, step 202 is the same as step 102, step 208 is the same as step 108, step 210 is the same as step 110, step 212 is the same as step 112, and step 214 is the same as step 214.

In this particular example, in step 206 the inverse conflicts assessor module 38 determines when any sets of received requirements have an inverse relationship requiring a determination of which one of the requirements to select before the complete conflict assessor module 36 in the project management computing device 12 determine two or more requirements completely contradict each other. The process the inverse conflicts assessor module 38 uses to determine when any sets of received requirements have an inverse relationship requiring a determination of which one of the requirements to select is the same as described earlier in step 106. If in step 206, inverse conflicts assessor module 38 determines any sets of received requirements do not have an inverse relationship requiring a determination of which one of the requirements to select, then the No branch is taken to step 212 which is the same process as described earlier with reference to step 112. If in step 206, inverse conflicts assessor module 38 determines any sets of received requirements have an inverse relationship requiring a determination of which one of the requirements to select, then the Yes branch is taken to step 208.

In step 208, the complete conflict assessor module 36 in the project management computing device 12 determine when two or more requirements completely contradict each other using the same process illustrated and described earlier with reference to step 108. If in step 208 the complete conflict assessor module 36 in the project management computing device 12 determine two or more requirements completely contradict, then the Yes branch is taken to step 208 which is the same process as illustrated and described with reference to step 108. If in step 208 the complete conflict assessor module 36 in the project management computing device 12 determine two or more requirements do not completely contradict, then the No branch is taken to step 212 which is the same process as illustrated and described with reference to step 112.

As illustrated and described by way of the examples herein, this technology provides methods, non-transitory computer readable medium and devices that select and sequence optimal project requirements in a project with multi-pass execution leading to earned value management maximization. In particular, this technology can automatically sequencing and scheduling of the execution of requirements across multiple phases of the project with effective management of partial and full conflicts. As a result, this technology generates scheduling data which has a global execution view as opposed to a local execution view. Further this technology is able avoid forbidden spaces with respect to particular designated requirements reflecting an organization's legal, business and/or logistic boundaries.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for optimizing sequencing and selecting requirements in a project, the method comprising:
obtaining, by a project management computing device, requirements data on two or more types of requirements for a project;
identifying, by the project management computing device, in the obtained requirements data each conflict between one of the requirements in one of the types of requirements and one of the requirements in another one of the types of requirements;
selecting, by the project management computing device, in each of the identified conflicts one of the one of the requirements in one of the types requirements or the one of the requirements in another one of the types of requirements based on stored attribute value data for the obtained requirements retrieved from one or more value databases; and
generating, by the project management computing device, a schedule with a sequence of execution in one or more phases of the project based on any non-conflicting ones of the requirements and the selected one of the one of the requirements in one of the types requirements and one of the requirements in another one of the types of requirements for each of the identified conflicts.

2. The method as set forth in claim 1 wherein the obtaining the requirements data on two or more types of requirements for a project further comprises indexing, by the project management computing device, each of the obtained requirements into one of the two or more types of requirements.

3. The method as set forth in claim 1 wherein the two or more types of requirements comprise two or more of business requirements, security requirements, reliability requirements, timing requirements, or performance requirements.

4. The method as set forth in claim 1 wherein the identifying in the obtained requirements data each conflict further comprises identifying, by the project management computing device each complete conflict between one of the requirements in one of the types requirements and one of the requirements in another one of the types of requirements.

5. The method as set forth in claim 1 wherein the identifying in the obtained requirements data each conflict further comprises:
identifying, by the project management computing device, each partial conflict between one of the requirements in one of the types of requirements and one of the requirements in another one of the types of requirements; and
determining, by the project management computing device, when the selecting is executed on each of the identified partial conflicts before the generating the schedule.

6. The method as set forth in claim 5 wherein the partial conflict between one of the requirements in one of the types of requirements and one of the requirements in another one of the types of requirements is an inverse relationship with a satisfaction value for the requirements below a stored threshold.

7. The method as set forth in claim 1 wherein the stored requirement value data obtained from one or more value databases further comprises stored requirement positive value data and stored requirement negative value data; and
wherein the selecting in each of the identified conflicts is further based on the positive value data for the one of the one of the requirements in one of the types requirements or the one of the requirements in another one of the types of requirements compared against the negative value data for the other one of the one of the requirements in one of the types requirements or the one of the requirements in another one of the types of requirements.

8. The method as set forth in claim 1 wherein the stored requirement value data obtained from one or more value databases comprises value data for at least one of the requirements comprises a designated forbidden value that indicates in the selecting the at least one of the requirements must be selected.

9. The method as set forth in claim 7 further comprising updating, by the project management computing device, one or more of the stored requirement positive value data or the stored requirement negative value data based on at least one of historical project execution data or updated input value data.

10. A project management computing device comprising:
at least one processor; and
a memory coupled to the processor which is configured to be capable of executing programmed instructions comprising and stored in the memory to:
obtain requirements data on two or more types of requirements for a project;
identify in the obtained requirements data each conflict between one of the requirements in one of the types of requirements and one of the requirements in another one of the types of requirements;
select in each of the identified conflicts one of the one of the requirements in one of the types requirements or the one of the requirements in another one of the types of requirements based on stored attribute value data for the obtained requirements retrieved from one or more value databases; and
generate a schedule with a sequence of execution in one or more phases of the project based on any non-conflicting ones of the requirements and the selected one of the one of the requirements in one of the types of requirements and one of the requirements in another one of the types of requirements for each of the identified conflicts.

11. The device as set forth in claim 10 wherein the processor coupled to the memory is further configured for the obtain the requirements data on two or more types of requirements for a project to be capable of executing at least one additional programmed instruction to index each of the obtained requirements into one of the two or more types of requirements.

12. The device as set forth in claim 10 wherein the two or more types of requirements comprise two or more of business requirements, security requirements, reliability requirements, timing requirements, or performance requirements.

13. The device as set forth in claim 10 wherein the processor coupled to the memory is further configured for the identify in the obtained requirements data each conflict to be capable of executing at least one additional programmed instruction to identify each complete conflict between one of the requirements in one of the types requirements and one of the requirements in another one of the types of requirements.

14. The device as set forth in claim 10 wherein the processor coupled to the memory is further configured for the identify in the obtained requirements data each conflict to be capable of executing at least one additional programmed instruction to:
identify each partial conflict between one of the requirements in one of the types of requirements and one of the requirements in another one of the types of requirements; and
determine when the selecting is executed on each of the identified partial conflicts before the generating the schedule.

15. The device as set forth in claim 14, wherein the partial conflict between one of the requirements in one of the types of requirements and one of the requirements in another one of the types of requirements is an inverse relationship with a satisfaction value for the requirements below a stored threshold.

16. The device as set forth in claim 10 wherein the stored requirement value data obtained from one or more value databases further comprises stored requirement positive value data and stored requirement negative value data; and
wherein the selecting in each of the identified conflicts is further based on the positive value data for the one of the one of the requirements in one of the types requirements or the one of the requirements in another one of the types of requirements compared against the negative value data for the other one of the one of the requirements in one of the types requirements or the one of the requirements in another one of the types of requirements.

17. The device as set forth in claim 10 wherein the stored requirement value data obtained from one or more value databases comprises value data for at least one of the requirements comprises a designated forbidden value that indicates in the selecting the at least one of the requirements must be selected.

18. The device as set forth in claim 16 wherein the processor coupled to the memory is further configured to be capable of executing at least one additional programmed instruction to update one or more of the stored requirement positive value data or the stored requirement negative value data based on at least one of historical project execution data or updated input value data.

19. A non-transitory computer readable medium having stored thereon instructions for optimizing sequencing and selecting requirements in a project which when executed by a processor, causes the processor to perform steps comprising:
obtaining requirements data on two or more types of requirements for a project;
identifying in the obtained requirements data each conflict between one of the requirements in one of the types of requirements and one of the requirements in another one of the types of requirements;
selecting in each of the identified conflicts one of the one of the requirements in one of the types requirements or the one of the requirements in another one of the types of requirements based on stored attribute value data for the obtained requirements retrieved from one or more value databases; and
generating a schedule with a sequence of execution in one or more phases of the project based on any non-conflicting ones of the requirements and the selected one of the one of the requirements in one of the types requirements and one of the requirements in another one of the types of requirements for each of the identified conflicts.

20. The medium as set forth in claim 19 wherein the obtaining the requirements data on two or more types of requirements for a project further comprises indexing each of the obtained requirements into one of the two or more types of requirements.

21. The medium as set forth in claim 19 wherein the two or more types of requirements comprise two or more of business requirements, security requirements, reliability requirements, timing requirements, or performance requirements.

22. The medium as set forth in claim 19 wherein the identifying in the obtained requirements data each conflict further comprises identifying, by the project management computing device each complete conflict between one of the requirements in one of the types requirements and one of the requirements in another one of the types of requirements.

23. The medium as set forth in claim 19 wherein the identifying in the obtained requirements data each conflict further comprises:
identifying each partial conflict between one of the requirements in one of the types of requirements and one of the requirements in another one of the types of requirements; and
determining when the selecting is executed on each of the identified partial conflicts before the generating the schedule.

24. The medium as set forth in claim 23 wherein the partial conflict between one of the requirements in one of the types of requirements and one of the requirements in another one of the types of requirements is an inverse relationship with a satisfaction value for the requirements below a stored threshold.

25. The medium as set forth in claim 19 wherein the stored requirement value data obtained from one or more value databases further comprises stored requirement positive value data and stored requirement negative value data; and
wherein the selecting in each of the identified conflicts is further based on the positive value data for the one of the one of the requirements in one of the types requirements or the one of the requirements in another one of the types of requirements compared against the negative value data for the other one of the one of the requirements in one of the types requirements or the one of the requirements in another one of the types of requirements.

26. The medium as set forth in claim 19 wherein the stored requirement value data obtained from one or more value databases comprises value data for at least one of the requirements comprises a designated forbidden value that indicates in the selecting the at least one of the requirements must be selected.

27. The medium as set forth in claim 25 further comprising updating one or more of the stored requirement positive value data or the stored requirement negative value data based on at least one of historical project execution data or updated input value data.
